(19) United States
(12) Patent Application Publication
(10) Pub. No.: US 2025/0173311 A1
(43) Pub. Date: May 29, 2025

(54) METHOD FOR GENERATING JOURNAL DATA, METHOD FOR PERFORMING JOURNAL REPLAY, AND STORAGE DEVICE

(71) Applicant: SAMSUNG ELECTRONICS CO., LTD., Suwon-si (KR)

(72) Inventors: Taehyung Kwon, Suwon-si (KR); Jeong-Eun Kim, Suwon-si (KR); Seunghwan Ha, Suwon-si (KR); Seungho Song, Suwon-si (KR)

(21) Appl. No.: 18/671,299

(22) Filed: May 22, 2024

(30) Foreign Application Priority Data
Nov. 28, 2023 (KR) 10-2023-0167885

(51) Int. Cl. G06F 16/18; G06F 16/16

(52) U.S. Cl. CPC G06F 16/1815; G06F 16/164

(57) ABSTRACT

A journal data generation method includes: receiving update information of meta data; obtaining a first meta data address from the update information; searching for a first journal having a second meta data address that matches the first meta data address; invalidating the first journal; and recording the update information as a second journal in a journal buffer where the first journal is recorded.

### CROSS-REFERENCE TO RELATED APPLICATIONS

This application claims priority to and the benefit of Korean Patent Application No. 10-2023-0167885, filed in the Korean Intellectual Property Office on Nov. 28, 2023, the entire contents of which is incorporated herein by reference.

### BACKGROUND

A memory system includes a memory device that records data and can read data, and a memory controller that controls the overall operation of the memory device. The memory device may include a non-volatile memory (NVM), in which stored data is not erased even if power is not supplied, and a volatile memory (VM), in which stored data is erased even if power is not supplied. In particular, a flash memory among the non-volatile memories uses meta data to ensure data reliability. As the high density and large capacity of flash memory are being researched, the time for initialization and setting operation of the memory device is also increasing.

### SUMMARY

In general, in some aspects, the present disclosure is directed toward a method and a storage device to generate journal data by removing dependencies between journals, which may include logs of meta data.

According to some aspects, the present disclosure is directed to a journal data generation method of a storage device that includes: receiving update information of meta data; obtaining a first meta data address from the update information; searching for a first journal having a second meta data address that matches the first meta data address; invalidating the first journal; and recording the update information as a second journal in a journal buffer where the first journal is recorded.

According to some aspects, the present disclosure is directed to a journal replay performing method of a storage device that includes: obtaining meta data; obtaining journal data that corresponds to the meta data, and includes journals of which meta data addresses are different from each other; dividing the journal data into at least two journal fragments; and recovering the meta data in parallel based on the at least two journal fragments by a plurality of replayers.

According to some aspects, the present disclosure is directed to a storage device that includes: a journal manager that determines a first journal corresponding to update information of metal data from among journal data when receiving the update information, and invalidates the first journal and generates a second journal; and a buffer memory that stores the meta data and the journal data.

### BRIEF DESCRIPTION OF THE DRAWINGS

FIG. 1 is a block diagram of an example of a storage system according to some implementations.

FIG. 2 is a block diagram of an example of a storage device according to some implementations.

FIGS. 3 to 6 are diagrams of examples of configurations for a journal data generator configured to generate journal data according to some implementations.

FIGS. 7 to 9 are diagrams of examples of configurations for a journal data generator configured to generate journal data according to some implementations.

FIG. 10 is a block diagram of an example of a storage device according to some implementations.

FIGS. 11 and 12 are examples of a journal search table according to some implementations.

FIGS. 13 and 14 are diagrams of examples of a search table according to some implementations.

FIG. 15 is a diagram of an example of operation of a storage device according to some implementations.

FIG. 16 is a diagram of an example of operation of a storage device according to some implementations.

FIG. 17 is a block diagram of an example of a storage device according to some implementations.

FIG. 18 is a diagram of an example of a configuration for a journal data replayer to perform the journal replay according to some implementations.

FIG. 19 is a diagram of an example of a configuration for a journal data replayer configured to perform journal replay according to some implementations.

FIG. 20 is a flowchart of an example of a journal data generation method according to some implementations.

FIG. 21 is a diagram of an example of an open time of a storage device according to some implementations.

FIG. 22 is a diagram of an example of a capacity of a storage device according to some implementations.

FIG. 23 is a block diagram of an example of a computing system according to some implementations.

FIG. 24 is a block diagram of an example of a computing system according to some implementations.

FIG. 25 is a block diagram of an example of a data center to which a computing system is applied according to some implementations.

### DETAILED DESCRIPTION

Hereinafter, example implementations will be explained in detail with reference to the accompanying drawings.

Like reference numerals designate like elements throughout the specification. In the flowchart described with reference to the drawing, the order of operations may be changed, several operations may be merged, certain operations may be divided, and certain operations may not be performed.

In addition, expressions written as singular may be interpreted as singular or plural, unless explicit expressions such as “one” or “single” are used. Terms containing ordinal numbers, such as first, second, and the like may be used to describe elements in various configurations, but components are not limited by these terms. These terms may be used to distinguish one component from another.

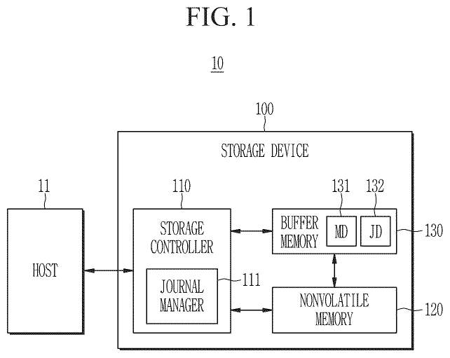

FIG. 1 is a block diagram of an example of a storage system according to some implementations. In FIG. 1, a storage system 10 may include a host 11 and a storage device 100. The host 11 may store data in the storage device 100 or read data stored in the storage device 100. The host 11 and the storage device 100 may control the storage device 100 based on a predetermined interface. In some implementations, the predetermined interface may be one of various interfaces such as advanced technology attachment (ATA), serial ATA (SATA), external SATA (e-SATA), a small computer small interface (SCSI), serial attached SCSI (SAS), peripheral component interconnection (PCI), PCI express (PCIe), NVM express (NVMe), institute of electrical and electronics engineers 1394 (IEEE 1394), universal serial bus (USB), secure digital (SD) card, advanced host controller interface (AHCI), multi-media card (MMC), embedded MMC (eMMC), universal flash storage (UFS), embedded UFS (eUFS), compact flash (CF) card, and the like.

The storage device 100 may be implemented as various types of storage devices, such as a solid-state drive (SSD), eMMC, UFS, CF, SD, Micro-SD, Mini-SD, extreme digital (xD), or a memory stick. The storage device 100 may include a storage controller 110, a non-volatile memory 120, and a buffer memory 130. The storage controller 110 may store data in the non-volatile memory 120 or read data stored in the non-volatile memory 120 according to control of the host 11.

In some implementations, the non-volatile memory 120 may operate according to the control of the storage controller 110. For example, the non-volatile memory 120 may be implemented as a NAND flash memory, a vertical NAND (VNAND) memory, an NOR flash memory, a resistive random access memory (RRAM), a phase-change RAM (PRAM), a conductive bridging RAM (CBRAM), a magneto resistive RAM (MRAM), a ferroelectric RAM (FRAM or FeRAM), or a spin transfer torque RAM (STT-RAM). However, examples of the non-volatile memory 120 are not necessarily limited thereto.

The buffer memory 130 may be formed to temporarily store data to be stored in the non-volatile memory 120 or data read from the non-volatile memory 120. In some implementations, the buffer memory 130 may be a dynamic RAM (DRAM), but this is not restrictive, and the buffer memory 130 may be one of various high-speed memories, such as a static RAM (SRAM).

In some implementations, the buffer memory 130 may store various pieces of information (e.g., meta data (MD), journal data (JD)) required for operation of the storage device 100. For example, the buffer memory 130 may include a first buffer 131 storing the meta data MD and a second buffer 132 storing the journal data JD.

The storage controller 110 may manage data stored in the non-volatile memory 120 through address conversion operation. The address conversion operation refers to a conversion operation between a logic block address managed by the host 11 and a physical block address of the non-volatile memory 120. The address conversion operation may be carried out through a mapping table. The mapping table may be stored in the buffer memory 130 and then managed by the buffer memory 130.

Hereinafter, the meta data MD will be described as a mapping table to easily describe example implementations of the present disclosure. However, the range of the present disclosure is not limited thereto, and the meta data MD may include various pieces of information required for operation of the storage device 100 other than the mapping table.

In some implementations, when the meta data MD is lost due to various factors, the reliability of data stored in the non-volatile memory 120 may not be guaranteed. In order to prevent such a loss of meta data MD, the storage controller 110 may generate journal data JD including update information of the meta data MD. For example, the storage controller 110 may include a journal manager 111 that generates the journal data JD. The journal manager 111 may record and manage update information of the meta data MD in the form of journal data JD. The journal data JD managed by the journal manager 111 may be stored in a buffer memory 130 disposed outside the storage controller 110. In some implementations, the journal manager 111 may store the journal data JD in an internal buffer included in the storage controller 110.

When the journal manager 111 generates journal data JD, it may remove dependencies between journals included in the journal data JD. Dependency between journals may occur when addresses indicated by the journals are the same. For example, the journal data JD may include a first journal to a third journal. The first journal may indicate a first address, the second journal may indicate a third address, which is different from the first address, and the third journal may address the first address. In this case, it may be expressed that the first journal and the third journal are dependent, and the second journal is not dependent on the first journal and the third journal.

The journal manager 111 may invalidate dependent journals among journal data JD. For example, the journal manager 111 may maintain the most recent journal among journals that are dependent on each other and invalidate existing journals. In some implementations, when generating the third journal after generating the first journal, the journal manager 111 may invalidate the first journal. For example, each journal includes a first value (e.g., 1) in a valid field, and correct a value in a valid field of the first journal to a second value (e.g., 0). In some implementations, the journal manager 111 may remove the first journal. In some implementations, the journal manager 111 may overwrite the third journal at a position where the first journal is recorded when the third journal is generated after generating the first journal.

When the second buffer 132 is full with the journal data JD, the storage controller 110 may transmit the journal data JD to the non-volatile memory 120. In this case, the storage controller 110 may transmit the meta data MD of the first buffer 131 to the non-volatile memory 120. That is, the storage controller 110 may record the journal data JD and the meta data MD together in the non-volatile memory 120 when the second buffer 132 is full.

The journal manager 111 may recover the meta data MD by replaying the journal data JD recorded in the non-volatile memory 120. For example, when the storage device 100 is turned on, the journal manager 111 may restore the meta data MD based on the journal data JD. For example, when the meta data MD is lost (e.g., in a situation such as sudden power off (SPO)), the journal manager 111 may restore the lost meta data MD based on the journal data JD.

Since the journal data JD stored in the non-volatile memory 120 has no dependency, the journal manager 111 may divide the journal data JD into a plurality of journal fragments and perform journal replay in parallel based on the plurality of journal fragments. Conventionally, the journal data JD includes dependent journals, journal replay needs to be performed sequentially according to the order in which the journal data JD was generated. Accordingly, the recovery time of the meta data MD was relatively long, and thus the preparation time (e.g., open time) for the storage device 100 to operate was also long. In comparison, the storage device 100 according to some implementations may perform journal replay in parallel, thereby shortening the recovery time of the meta data MD, and thus the preparation time for the storage device 100 to operate also may be reduced.

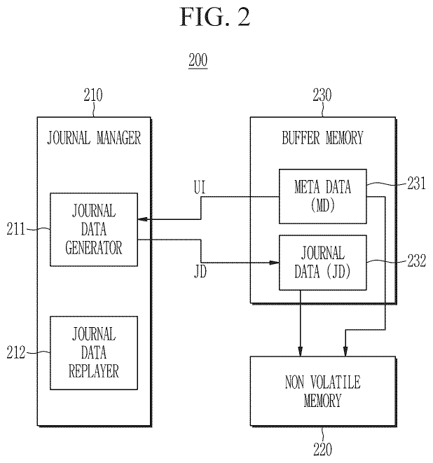

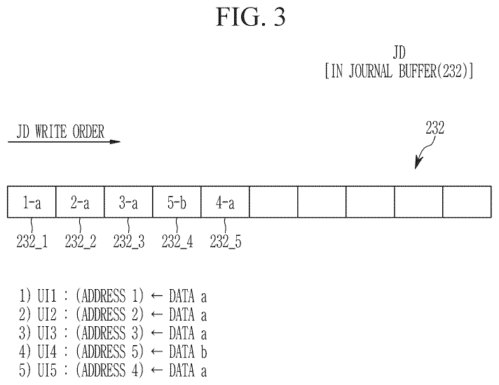

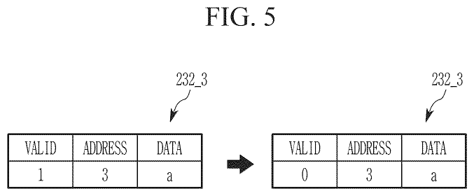

FIG. 2 is a block diagram of an example of a storage device according to some implementations, and FIGS. 3 to 6 are diagrams of examples of configurations for a journal data generator configured to generate journal data according to some implementations. In FIG. 2, the storage device 200 may include a journal manager 210, a non-volatile memory 220, and a buffer memory 230. The buffer memory 230 may include a meta buffer 231 storing meta data MD and a journal buffer 232 storing journal data JD.

The non-volatile memory 220 may store data according to the control (e.g., control of read operation, write operation, erase operation, and the like) of the storage controller 110. According to the control of the storage controller 110, the meta data MD stored in the meta buffer 231 may be updated. In some implementations, the update of the meta data MD may be carried out by a flash translation layer (FTL) included in the storage controller 110. The journal manager 210 may be implemented by being included in the storage controller 110.

The journal manager 210 may generate and manage the journal data JD. For example, the journal manager 210 may include a journal data generator 211 and a journal data replayer 212.

The journal data generator 211 may generate the journal data JD based on update information UI of the meta data MD. That is, the journal data JD may include information indicating how the meta data MD is updated, and when some information in the meta data MD is lost, the lost information may be restored through the journal data JD.

The journal data generator 211 may remove inter-journal dependencies of the journal data JD. In other words, the journal data generator 211 may generate journal data JD such that addresses indicated by the journal do not overlap.

The journal data JD generated by the journal data generator 211 may be stored in the journal buffer 232. In FIG. 2, the journal buffer 232 is disposed outside the journal manager 210, but it is not limited thereto, and may be implemented as an internal memory, an internal buffer, or an internal SRAM included in the storage controller 110. The journal buffer 232 may accumulate and store the journal data JD generated from the journal data generator 211. When the journal buffer 232 is full, the journal buffer 232 may move the journal data JD to the non-volatile memory 220.

The meta data MD stored in the meta buffer 231 may be flushed to the non-volatile memory 220 periodically or aperiodically while the storage device 200 is operating. In some implementations, the meta data MD may be flushed together with the journal data JD to the non-volatile memory 220. In the non-volatile memory 220, the meta data MD and the journal data JD may be stored in a single level cell (SLC) region.

In FIGS. 2 and 3, the journal data generator 211 may sequentially receive update information UI1 to UI5 according to update of the meta data MD. The journal data generator 211 may generate the journal data JD based on the update information UI1 to UI5 and record the generated journal data JD in the journal buffer 232. The journal buffer 232 may include a plurality of memories 232_1 to 232_5. The journal data generator 211 may sequentially record the journal data JD in the plurality of memories 232_1 to 232_5. In some implementations, the order in which journal data JD is generated may be related to the update order of meta data MD.

For example, the update information UI1 to UI5 may include “record data a in a first address ADDRESS1 (UI)”, “record data a in a second address ADDRESS2 (UI2)”, “record data a in a third address ADDRESS3 (UI3)”, “record data b in a fifth address ADDRESS5 (UI4)”, and “record data a in a fourth address ADDRESS4 (UI5)”. The first to fifth addresses ADDRESS1 to ADDRESS5 may imply addresses of meta data MD. The journal data generator 211 may generate journal data JD corresponding to the update information UI1 to UI5 and record the journal data JD in the plurality of memories 232_1 to 232_5. The journal data JD may include first to fifth journals 1-a, 2-a, 3-a, 5-b, and 4-a.

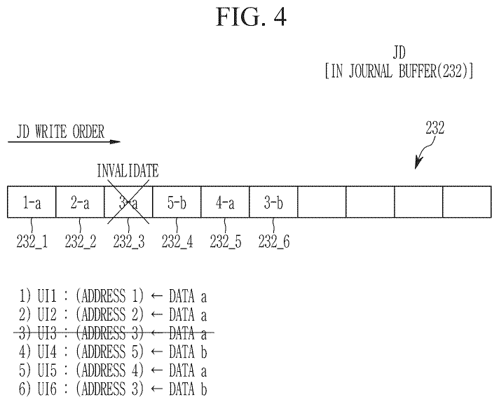

In FIGS. 2 and 4, according to the update of the meta data MD, the journal data generator 211 may further receive update information UI6. The update information UI6 may include “record data b in the third address ADDRESS3”. The journal data generator 211 may generate a sixth journal 3-b based on the update information UI6. The journal data generator 211 may record the sixth journal 3-b in a memory 232_6.

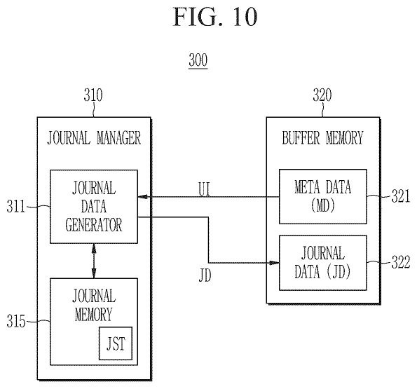

The journal data generator 211 may determine whether there is journal data JD with the same address (i.e., the third address ADDRESS3) as the newly generated sixth journal 3-b. For example, the journal data generator 211 may search journal data JD in the journal buffer 232 using a hash table, a binary search tree, and the like. The configuration of the journal data generator 211 to search the journal data JD will be described later with reference to FIGS. 10 to 14.

The journal data generator 211 may determine that the third journal 3-a of the memory 232_3 in the journal buffer 232 has the same address as the sixth journal 3-b. The journal data generator 211 may invalidate the third journal 3-a of the memory 232_3. In some implementations, the journal data generator 211 may change a value of the valid field of the third journal 3-a. In some implementations, the journal data generator 211 may overwrite the memory 232_3 with the sixth journal 3-b.

In FIGS. 2, 4, and 5, the third journal 3-a stored in the memory 232_3 may include a valid field VALID, an address field ADDRESS, and a data field DATA. In the third journal 3-a, the valid field may have a value of “1”, the address field may have a value of “3”, and the data field may have a value of “a”. The journal data generator 211 may invalidate the third journal 3-a by changing the value of the valid field. For example, the journal data generator 211 may initially set the value of the valid field to a first value (e.g., 1) when recording the third journal 3-a in the memory 232_3. Then, the journal data generator 211 may record the sixth journal 3-b in the memory 232_6, and may correct the value of the valid field of the third journal 3-a in the memory 232_3 to a second value (e.g., 0). Accordingly, the third journal 3-a may be invalidated.

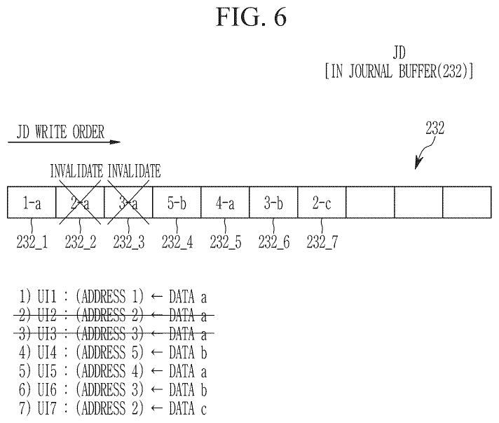

In FIGS. 2 and 6, according to the update of the meta data MD, the journal data generator 211 may further receive update information UI7. The update information UI7 may include “record data c in the second address ADDRESS2”. The journal data generator 211 may generate a seventh journal 2-c based on the update information UI7. The journal data generator 211 may record the seventh journal 2-c in the memory 232_7.

The journal data generator 211 may determine whether there is journal data JD with the same address (i.e., second address ADDRESS2) as the newly generated seventh journal 2-c. The journal data generator 211 may determine that the second journal 2-a of the memory 232_2 in the journal buffer 232 has the same address as the seventh journal 2-c. The journal data generator 211 may invalidate the second journal 2-a of the memory 232_2. In some implementations, the journal data generator 211 may overwrite the memory 232_2 with the seventh journal 2-c.

In some implementations, the journal data generator 211 may manage the values of the valid fields of the journal data JD in a bitmap format. For example, the journal data generator 211 may manage the values of the valid fields of the journal data JD, such as “1001111”. The journal data generator 211 may manage valid and invalid journals through values in bitmap format.

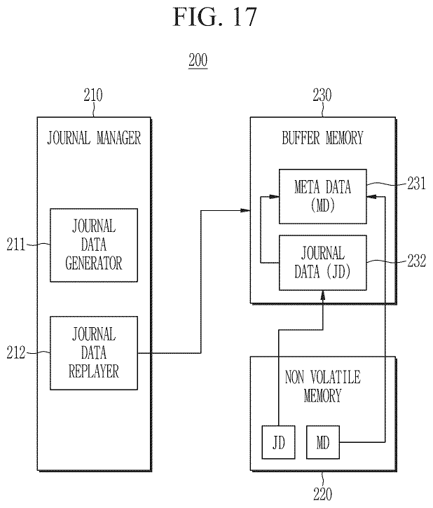

The journal data replayer 212 may be configured to replay journal data JD to recover meta data MD. The operation of the journal data replayer 212 will be described later with reference to FIGS. 17 to 19.

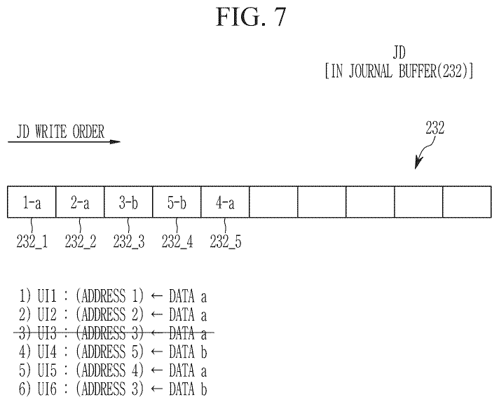

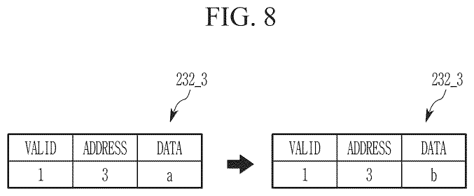

FIGS. 7 to 9 are diagrams of examples ofconfigurations for a journal data generator to generate journal data according to some implementations. In FIGS. 2, 3, and 7, the journal data generator 211 may record journal data JD in a plurality of memories 232_1 to 232_5 based on update information UI1 to UI5. According to the update of the meta data MD, the journal data generator 211 may further receive update information UI6. The update information UI6 may include “record data b to the third address ADDRESS3”. The journal data generator 211 may generate the sixth journal 3-b based on the update information UI6.

The journal data generator 211 may determine whether there is journal data JD with the same address (third address (ADDRESS3)) as the newly generated sixth journal 3-b. The journal data generator 211 may determine that the third journal 3-a of the memory 232_3 in the journal buffer 232 has the same address as the sixth journal 3-b. The journal data generator 211 may record the sixth journal 3-b in the memory 232_3. In other words, the journal data generator 211 may overwrite the memory 232_3 with the sixth journal 3-b.

In FIGS. 2, 7, and 8, the third journal 3-a stored in the memory 232_3 may include a valid field VALID, an address field ADDRESS, and a data field DATA. In the third journal 3-a, a value of a valid field may be “1”, a value of an address field may be “3”, and a value of a data field may be “a”. The journal data generator 211 may invalidate the third journal 3-a by changing the value of the data field. For example, the journal data generator 211 may overwrite the memory 232_3 with the sixth journal 3-b. In the sixth journal 3-b, a value of a valid field may be “1”, a value of an address field may be “3”, and a value of a data field may be “b”. In other words, the journal data generator 211 may correct the value of the data field in memory 232_3 from “a” to “b”. Accordingly, the third journal 3-a may be invalidated. In some implementations, the journal data JD may be implemented to include an address field and a data field without including a valid field. In other words, when the journal data generator 211 overwrites the journal in the journal buffer 232, the journal data JD may not include valid fields because dependency between journals does not occur.

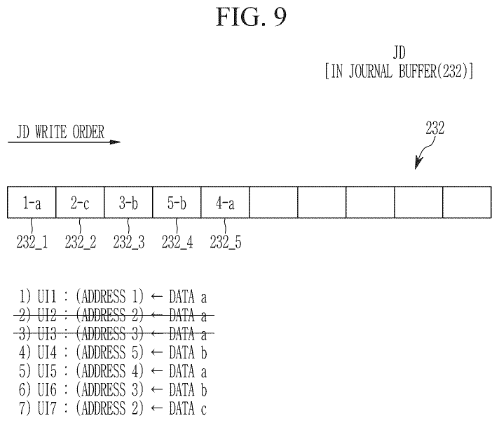

In FIGS. 2 and 9, according to update of the meta data MD, the journal data generator 211 may further include update information UI7. The update information UI7 may include “record data c in the second address ADDRESS2”. The journal data generator 211 may generate a seventh journal 2-c based on the update information UI7.

The journal data generator 211 may determine whether there is journal data JD with the same address (second address (ADDRESS2)) as the newly generated seventh journal 2-c. The journal data generator 211 may determine that the second journal 2-a of the memory 232_2 in the journal buffer 232 has the same address as the seventh journal 2-c. The journal data generator 211 may record the seventh journal 2-c in the memory 232_2. That is, the journal data generator 211 may overwrite the memory 232_2 with the seventh journal 2-c.

FIG. 10 is a block diagram of an example of a storage device according to some implementations. In FIG. 10, a storage device 300 may include a journal manager 310 and a buffer memory 320. The buffer memory 320 may include a meta buffer 321 storing meta data MD and a journal buffer 322 storing journal data JD. The description for the meta buffer 231 and the journal buffer 232 of FIG. 2 may be equally applied to the meta buffer 321 and the journal buffer 322. Accordingly, redundant descriptions will be omitted.

The journal manager 310 may include a journal data generator 311 and a journal memory 315. The journal memory 315 may be implemented as an internal memory, an internal buffer, or an internal SRAM included in the journal manager 310. In some implementations, the journal memory 315 may be placed outside the journal manager 310.

The journal memory 315 may include a journal search table (JST) for searching journal data JD stored in the journal buffer 322. The journal search table JST may include a journal buffer identifier (or index) and a meta data address corresponding to the journal buffer identifier. The journal buffer identifier may imply one of memories (e.g., 232_1 to 232_5 of FIG. 3) included in the journal buffer 322. The meta data address may imply an address of meta data MD indicated by the journal data JD of the memory. The journal search table JST may be implemented as a hash table, binary search tree, and the like.

The journal data generator 311 may generate journal data JD using the journal search table JST. The journal data generator 311 may generate journal data JD such that journals in the journal data JD do not have the same meta data address. For example, the journal data generator 311 may receive first update information according to updates of meta data. The journal data generator 311 may acquire a first meta data address from the first update information.

The journal data generator 311 may search a journal having the first meta data address among journal data JD using the journal search table JST. The journal data generator 311 may generate a new journal based on the first update information when no journal having the first meta data address searched in the journal data JD. The journal data generator 311 may invalidate a first journal by searching for the journal (e.g., the first journal) with the first meta data address among the journal data JD. The journal data generator 311 may invalidate the first journal and generate a new journal based on the first update information. In some implementations, the journal data generator 311 may overwrite a memory where the first journal is stored with the new journal. The new journal may be included in the journal data JD.

In FIG. 10, the storage device 300 includes the journal manager 310 and the buffer memory 320 for better understanding and ease of description, but some implementations are not limited thereto, and the storage device 300 may further include components necessary for data storage, such as a non-volatile memory.

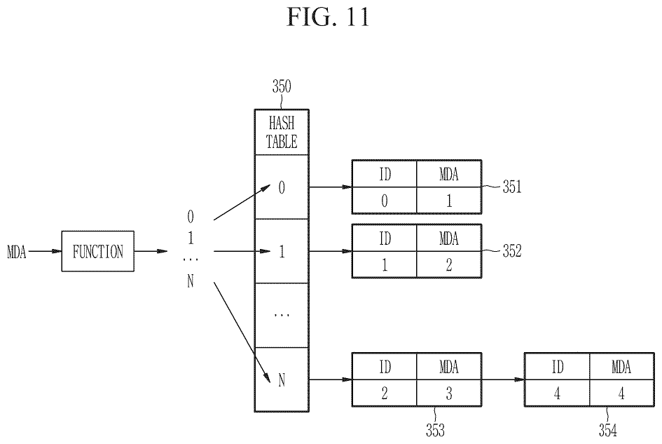

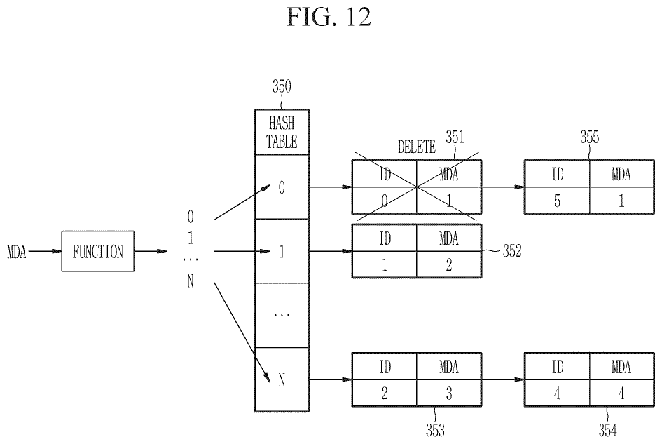

FIGS. 11 and 12 are examples of a journal search table according to some implementations. In FIGS. 10 and 11, the journal search table JST may be implemented in the form of a hash table 350. That is, the journal memory 315 may store the hash table 350. The journal data generator 311 may receive update information UI according to update of meta data MD. The journal data generator 311 may acquire a meta data address MDA from the update information UI. The journal data generator 311 may search for a journal with the meta data address MDA among the journal data JD stored in the journal buffer 322.

In some implementations, the journal data generator 311 may generate an operation value based on the meta data address MDA. The journal data generator 311 may search for a journal in the hash table 350 based on the operation value. For example, the journal data generator 311 may generate an operation value using a function in the meta data address MDA. The operation value may be in a range of 0 to N (N is an integer greater than 1). In some implementations, a function may be implemented as a modular function, a hash function, a random number generation function, and the like.

The hash table 350 may store journal information based on the operation value. The journal information may include the meta data address MDA and a journal buffer identifier ID. For example, the journal data generator 311 may store the meta data address MDA and the journal buffer identifier ID as a pair of key and value in the hash table 350. In the hash table 350, the meta data address MDA may correspond to the key, and the journal buffer identifier ID may correspond to the value.

For example, the hash table 350 may contain first to fourth pairs 351 to 354. The first pair 351 shows that a journal included in a memory (e.g., one of the memories 232_1 to 232_5 of FIG. 3) of which a journal buffer identifier ID is “0” in the journal buffer 322 indicates a meta data address MDA “1”. The second pair 352 shows that a journal included in a memory (e.g., one of the memories 232_1 to 232_5 of FIG. 3) of which a journal buffer identifier ID is “1” in the journal buffer 322 indicates a meta data address MDA “2”. The third pair 353 shows that a journal included in a memory (e.g., one of the memories 232_1 to 232_5 of FIG. 3) of which a journal buffer identifier ID is “1” in the journal buffer 322 indicates a meta data address MDA “3”. The fourth pair 354 shows that a journal included in a memory (e.g., one of the memories 232_1 to 232_5 of FIG. 3) of which a journal buffer identifier ID is “4” in the journal buffer 322 indicates a meta data address MDA “4”.

The hash table 350 may store the first to fourth pairs 351 to 354 based on the operation value. For example, the first pair 351 may correspond to the operation value “0”, the second pair 352 may correspond to the operation value “1”, and the third and fourth pairs 353 and 354 may correspond to the operation value “N”.

The journal data generator 311 may search for journal information with an operation value that matches the operation value of the meta data address MDA in the hash table 350. When there is journal information with the operation value of the meta data address MDA, the journal data generator 311 may invalidate the journal of the journal data JD based on the journal information.

For example, the journal data generator 311 may obtain the operation value “0” by using a function in the meta data address MDA. The journal data generator 311 may search for the first pair 351 corresponding to the operation value “0” in hash table 350. The journal data generator 311 may obtain the journal buffer identifier ID “0” and meta data address MDA “1” from the first pair 351. The journal data generator 311 may generate a journal and record the journal in the journal buffer 322 based on the journal buffer identifier ID “0”. The journal data generator 311 may store journal information of the newly generated journal in the hash table 350.

In FIGS. 10 and 12, the journal data generator 311 may store journal information of the newly recorded journal in the hash table 350 as a fifth pair 355. The fifth pair 355 shows that a journal included in a memory of which a journal buffer ID is “5” in the journal buffer 322 indicates the meta data address MDA “1”. The journal data generator 311 may remove the first pair 351.

The journal data generator 311 may invalidate a journal corresponding to the first pair 351. That is, the journal data generator 311 may invalidate a journal stored in a memory of which the journal buffer ID in the journal buffer 322 is “0”. In some implementations, the journal data generator 311 may change a value of a valid field of the journal. For example, the journal data generator 311 may change the value of the valid field from “1” to “0”. As the journal data generator 311 changes the value of the valid field, the journal may be invalidated.

In some implementations, the journal data generator 311 may overwrite a new journal in the memory where the journal buffer ID is “0” in the journal buffer 322. An existing journal stored in memory may be removed. In this case, the journal data generator 311 may not generate the fifth pair 355. That is, the journal data generator 311 may maintain the first pair 351 rather than removing the first pair 351.

In FIGS. 10 and 11, the journal data generator 311 may generate a new journal in the journal buffer 322 when there is no journal information with the operation value of the meta data address MDA in the hash table 350. The journal data generator 311 may record journal information of the new journal in the hash table 350. For example, the journal data generator 311 may generate a new pair in the hash table 350 based on an operation value of the new journal. The new pair may include a meta data address MDA and a journal buffer ID corresponding to the meta data address MDA. The contents described with reference to FIG. 12 may be equally applied as a configuration in which the journal data generator 311 records new journal information.

In some implementations, the third pair 353 and the fourth pair 354 have different meta data addresses MDA of “3” and “4”, but they may be searched at the same position in the hash table 350 because they have the same operation value “N” through a function. For example, the journal data generator 311 may obtain the operation value N from update information UI received according to the update of the meta data MD. The meta data address of the update information UI may be “3”. The journal data generator 311 may search for the third pair 353 and the fourth pair 354 corresponding to the operation value “N” from the hash table 350. The journal data generator 311 may check meta data addresses MDA of the third pair 353 and the fourth pair 354. The journal data generator 311 may search for the third pair 353 of which the meta data address MDA is “3”, and may invalidate a journal corresponding to the third pair 353 based on journal information of the third pair 353. The journal data generator 311 may pass the fourth pair 354 of which the meta data address MDA is “4”.

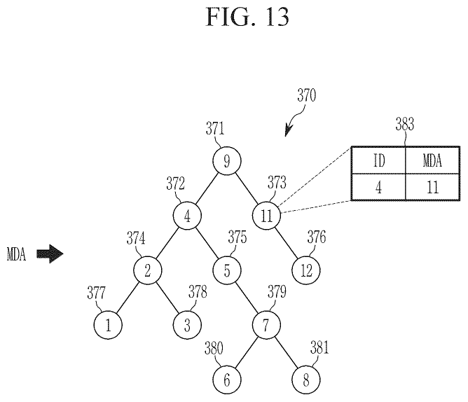

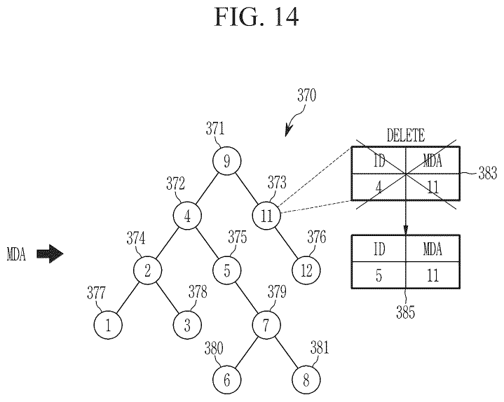

FIGS. 13 and 14 are diagrams of examples of a search table according to some implementations. In FIGS. 10 and 13, a journal search table JST may be implemented in the form of a binary search tree 370. That is, the journal memory 315 may store the binary search tree 370.

The journal data generator 311 may receive update information UI according to update of meta data MD. The journal data generator 311 may obtain the meta data address MDA from the update information UI. The journal data generator 311 may search for a journal having the meta data address MDA from the journal data JD stored in the journal buffer 322.

The journal data generator 311 may search for the journal from the binary search tree 370 based on the meta data address MDA. The binary search tree 370 may store journal information based on the meta data address MDA. The journal information may include a meta data address MDA and a journal buffer identifier ID. For example, the journal data generator 311 may store the meta data address MDA and the journal buffer identifier ID as a key and value pair in the binary search tree 370. In the binary search tree 370, the meta data address MDA may correspond to a key, and the journal buffer identifier ID may correspond to a value.

For example, the binary search tree 370 may include a plurality of nodes 371 to 381. A first node 371 represents journal information of a journal of which the meta data address MDA is “9” among the journal data JD stored by the journal buffer 322. Likewise, second to eleventh nodes 372 to 381 represent journal information of journals of which meta data addresses MDA are “4”, “11”, “2”, “5”, “12”, “1”, “3”, “7”, “6”, and “8”.

The journal data generator 311 may search for journal information that matches the meta data address MDA from the binary search tree 370. When there is journal information having the meta data address MDA, the journal data generator 311 may invalidate the journal of journal data JD based on the journal information.

For example, the journal data generator 311 may obtain the meta data address MDA “11”. The journal data generator 311 may search for a third node 373 corresponding to the meta data address MDA “11” from the binary search tree 370.

The journal data generator 331 may move nodes by comparing the plurality of nodes 371 to 381. The journal data generator 331 may start the comparison from the first node 371. Since meta data address MDA “11” is greater than “9”, a value of first node 371, the journal data generator 331 may move to a third node 373 at the right of the first node 371.

Since a value of the third node 373 is “11”, the journal data generator 331 may obtain journal information 383 of the third node 373. The journal data generator 331 may obtain journal buffer identifier ID “4” corresponding to the meta data address MDA “11” from the journal information 383. The journal data generator 311 may generate a journal, and may record the journal in the journal buffer 322 based on the journal buffer identifier ID “4”. The journal data generator 311 may store journal information of the newly generated journal in the binary search tree 370.

In FIGS. 10 and 14, the journal data generator 311 may generate a journal of which the meta data address MDA is “11”. The journal data generator 311 may record the generated journal in a memory of which the journal buffer identifier ID is “5” among the journal buffer 322. The journal data generator 311 may record the journal, and may store journal information 385 of the newly recorded journal in the third node 373 of the binary search tree 370. The journal data generator 311 may remove the journal information 383.

The journal data generator 311 may invalidate the journal corresponding to the journal information 383. That is, the journal data generator 311 may validate a journal stored in a memory of which the journal buffer identifier ID is “4” from the journal buffer 322. In some implementations, the journal data generator 311 may change a value of a valid field of the journal. For example, the journal data generator 311 may change the value of the valid field from “0” to “1”. The journal may become invalid when the journal data generator 311 changes the value of the valid field.

In some implementations, the journal data generator 311 may overwrite a new journal to the memory of which the journal buffer identifier ID is “4” in the journal buffer 322. An existing journal stored in the memory may be removed. In this case, the journal data generator 311 may not generate the journal information 385. That is, the journal data generator 311 may maintain the journal information 383 rather than removing the journal information 383.

In FIGS. 10 and 13, the journal data generator 311 may generate a new journal in the journal buffer 322 when no journal information having a meta data address MDA exists in the binary search tree 370. The journal data generator 311 may record journal information of the new journal in the binary search tree 370. That is, the journal data generator 311 may generate a new node in the binary search tree 370 and store journal information in the new node.

In some implementations, the journal search table JST may be implemented as a ternary tree, a balanced tree (B-tree), an unbalanced tree, and the like.

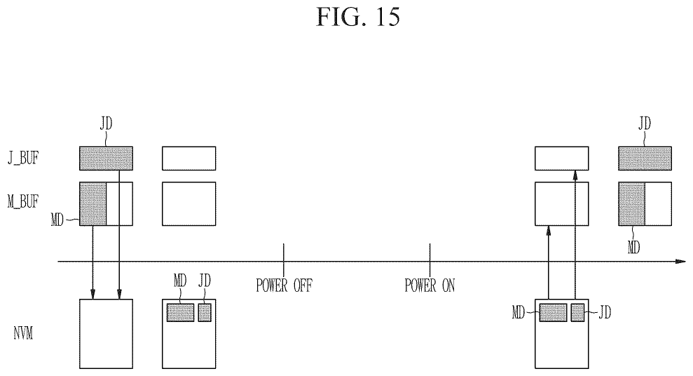

FIG. 15 is a diagram of an example of operation of a storage device according to some implementations. In FIG. 15, a storage device may include a journal manager, a buffer memory, and a non-volatile memory NVM. The buffer memory may include a meta buffer M_BUF storing meta data MD and a journal buffer J_BUF storing journal data JD. The contents described referring to FIG. 1 may be applied equally to the journal manager, the buffer memory, and the non-volatile memory NVM. Accordingly, redundant descriptions will be omitted.

The journal manager may generate the journal data JD based on update information of the meta data MD. The journal manager may record the journal data JD in the journal buffer J_BUF. The journal manager may remove the dependency of the journal data JD. For example, the journal manager may obtain a meta data address from the update information, and may determine a journal having the same meta data address from among existing journals. The journal manager may invalidate the determined journal. In some implementations, the journal manager may correct a value of a valid bit of the determined journal. In some implementations, the journal manager may replace the determined journal with a new journal. That is, the journal manager may overwrite a new journal in the journal buffer J_BUF.

When the journal buffer J_BUF is full with journal data JD, the journal buffer J_BUF may move the journal data JD to the non-volatile memory NVM. The operation of the journal buffer J_BUF to move journal data JD may be understood as a flush operation. In some implementations, the journal manager may move the journal data JD to the non-volatile memory NVM.

The meta buffer M_BUF may move the meta data MD to the non-volatile memory NVM when the journal data JD is moved. In some implementations, the journal manager may move meta data MD to the non-volatile memory NVM.

The non-volatile memory NVM may store the meta data MD and the journal data JD according to the flush operation. Accordingly, even if the storage device is turned off, the non-volatile memory NVM may maintain the meta data MD and the journal data JD. The buffer memory is a volatile memory, and when the storage device is turned off, the buffer memory may not store any data. When the storage device is turned on, the journal manager may move the meta data MD and the journal data JD from the non-volatile memory NVM to the buffer memory for operation of the storage device. The journal manager may record the meta data MD in the meta buffer M_BUF and the journal data JD in the journal buffer J_BUF.

The journal manager may perform journal replay based on the journal data JD. For example, the journal manager may split the journal data JD into a plurality of journal fragments. The journal manager may contain a plurality of journal replayers that perform journal replay using each journal fragment. Accordingly, the storage device may perform the journal replay in parallel, which can shorten the recovery time of the meta data MD, and thus the preparation time for the storage device to operate can also be reduced.

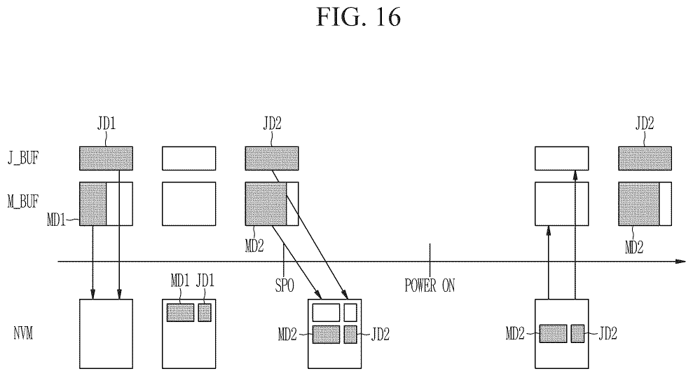

FIG. 16 is a diagram of an example of operation of a storage device according to some implementations. In FIG. 16, a storage device may include a journal manager, a buffer memory, and a non-volatile memory NVM. The buffer memory may include a meta buffer M_BUF, which stores meta data MD1 and meta data MD2, and a journal buffer J_BUF, which stores journal data JD1 and journal data JD2. The contents described referring to FIG. 1 may be applied equally to the journal manager, the buffer memory, and the non-volatile memory NVM. Accordingly, redundant descriptions will be omitted.

The journal manager may generate the journal data JD1 based on update information of the meta data MD. The journal manager may record the journal data JD1 in the journal buffer J_BUF. The journal manager may remove the dependency of the journal data JD1. For example, the journal manager may obtain a meta data address from the update information, and may determine a journal having the same meta data address from among existing journals. The journal manager may invalidate the determined journal. In some implementations, the journal manager may correct a value of a valid bit of the determined journal. In some implementations, the journal manager may replace the determined journal with a new journal. That is, the journal manager may overwrite a new journal in the journal buffer J_BUF.

In addition, the journal manager may generate the journal data JD2 based on update information of the meta data MD2. As the storage device operates, data may be recorded in the non-volatile memory NVM or data in the non-volatile memory NVM may be erased. As the data stored by the non-volatile memory NVM changes, the meta data MD1 and meta data MD2 may be continuously updated.

The journal manager may record the journal data JD2 in the journal buffer J_BUF. The journal manager may remove the dependency of the journal data JD2. The operation of the journal manager to remove the dependency of journal data JD2 may be applied in the same way as the description of the operation of the journal manager to remove the dependency of journal data JD1.

In some implementations, the storage device may experience a sudden power off SPO situation. The storage device may include an auxiliary power supplying power in the sudden power off SPO situation. The auxiliary power may be implemented with a capacitor module, and the like.

Although the sudden power off SPO situation occurs, the buffer memory may retain data because the storage device uses the auxiliary power. In other words, the journal buffer J_BUF may maintain the journal data JD2, and the meta buffer M_BUF may maintain the meta data MD2.

The buffer memory may move the journal data JD2 and the meta data MD2 to the non-volatile memory NVM in response to the sudden power off SPO situation. In some implementations, the journal manager may move the journal data JD2 to the non-volatile memory NVM.

The meta buffer M_BUF may move the meta data MD2 to the non-volatile memory NVM when the journal data JD2 is moved. In some implementations, the journal manager may move the meta data MD2 to the non-volatile memory NVM.

The non-volatile memory NVM may store the meta data MD2 and the journal data JD2. The non-volatile memory NVM may erase the previously stored meta data MD1 and journal data JD1 by storing the meta data MD2 and the journal data JD2.

In some implementations, the non-volatile memory NVM may have a region of a predetermined size for the meta data MD1 and the meta data MD2 and the journal data JD1 and the journal data JD2. The non-volatile memory NVM may erase existing data when receiving new data if the region is full. The size of the region may be determined in advance by the storage device manufacturer's specifications. In other words, when the region is large, the meta data MD1 and the journal data JD1 may not be deleted. The region for the meta data MD1 and the meta data MD2 and the journal data JD1 and journal data JD2 may be an SLC region.

The storage device may process the meta data MD1 and the meta data MD2 and the journal data JD1 and the journal data JD2 and turn off the auxiliary power. Although the storage device is turned off, the non-volatile memory NVM may maintain the meta data MD2 and the journal data JD2. The buffer memory is a volatile memory, and when the storage device is powered off, the buffer memory may not store any data.

When the storage device is turned on, the journal manager may move the meta data MD2 and the journal data JD2 from the non-volatile memory NVM to the buffer memory for the operation of the storage device. The journal manager may record the meta data MD2 in the meta buffer M_BUF and the journal data JD2 in the journal buffer J_BUF.

The journal manager may perform journal replay based on the journal data JD2. For example, the journal manager may split the journal data JD2 into a plurality of journal fragments. The journal manager may contain a plurality of journal replayers that perform journal replay using each journal fragment. Accordingly, the storage device may perform journal replay in parallel, which can shorten the recovery time of meta data MD2, and thus the preparation time for the storage device to operate can also be reduced.

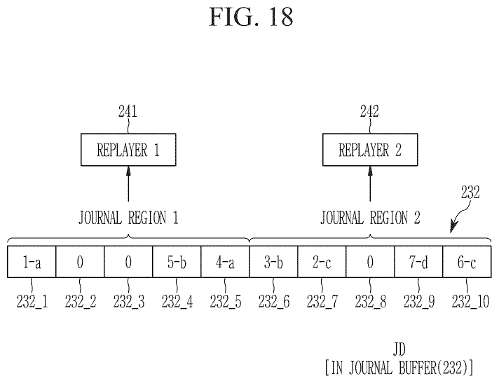

FIG. 17 is a block diagram of an example of a storage device according to some implementations, and FIG. 18 is a diagram of an example of a configuration for a journal data replayer to perform the journal replay according to some implementations. In FIG. 17, a storage device 200 may include a journal manager 210, a non-volatile memory 220, and a buffer memory 230. The buffer memory 230 may include a meta buffer 231 storing meta data MD and a journal buffer 232 storing journal data JD.

The journal manager 210 may include a journal data generator 211 and a journal data replayer 212. The description of the journal data generator of FIG. 2 may be equally applied to the journal data generator 211. Accordingly, redundant descriptions will be omitted.

The non-volatile memory 220 may include journal data JD and meta data MD for operation of the storage device 200. When the storage device 200 is turned on, the meta data MD may be loaded into the meta buffer 231, and the journal data JD may be loaded into the journal buffer 232. According to some implementations, the journal manager 210 or the storage controller 110 of FIG. 1 may move the meta data MD and the journal data JD.

In this case, the meta data MD loaded to the meta buffer 231 may not be the latest version, and in this case, the reliability of data stored in the non-volatile memory 220 cannot be guaranteed. Accordingly, an operation to restore the meta data MD to the latest version may be required.

The journal data replayer 212 may restore the meta data MD to the latest version based on the journal data JD of the journal buffer 232. The journal data replayer 212 may divide the journal data JD and perform replay individually or in parallel. For example, the journal data replayer 212 may split the journal data JD into a plurality of journal fragments. The journal data replayer 212 may include a plurality of journal replayers that perform journal replay using each journal fragment. Each journal replayer may recover meta data MD using individual journal fragments.

In FIGS. 17 and 18, the journal data replayer 212 may split the journal data JD of the journal buffer 232. The journal buffer 232 may include a plurality of memories 232_1 to 232_10. The journal data JD includes a first journal to a tenth journal and may be stored in the plurality of memories 232_1 to 232_10.

The first journal to the tenth journal may have no dependencies. The first journal may instruct to record data “a” in the meta data address “1”, the fourth journal may instruct to record data “b” in the meta data address “5”, and the fifth journal may instruct to record the data “b” in the meta data address “4”, the sixth journal may instruct to record the data “b” in the meta data address “3”, and the seventh journal may instruct to record data “c” in the meta data address “2”, the ninth journal may instruct to record data “d” in the meta data address “7”, and the tenth journal may instruct to record the data “c” in the meta data address “6”.

In the journal data JD of FIG. 18, journals with duplicate meta data addresses are invalidated. For example, a second journal, a third journal, and an eighth journal may be invalidated journals. Value of valid fields for the second journal, third journal, and eighth journal may be “0”. For the first journal, fourth to seventh journal, ninth journal, and tenth journal, values of valid fields may be “1”.

The journal data replayer 212 may divide the journal data JD of the journal buffer 232 to a first journal region JOURNAL REGION 1 and a second journal region JOURNAL REGION 2. The first journal region may contain the first to fifth journals, and the second journal region may contain the sixth to tenth journals.

The journal data replayer 212 may include a first replayer (REPLAYER1) 241 and a second replayer (REPLAYER2) 242. In some implementations, the first replayer 241 and the second replayer 242 may be implemented as individual logic circuits. In some implementations, the first replayer 241 and the second replayer 242 may also be implemented as being included in the storage controller 110 of FIG. 1.

The number of replayers included in the journal data replayer 212 may be determined according to the specifications of the manufacturer of the storage device 200. For example, the manufacturer's specifications may include an open time (referred to as T_OPN) until the storage device 200 is turned on and starts operating. The manufacturer may obtain a replay time (referred to as T_ONE) when performing replay based on journal data JD with only one replayer. The manufacturer may determine a value of a variable P such that (T_OPN)≥(T_ONE)/P (P is an integer greater than 1). The manufacturer may include P number of replayers in the journal data replayer 212. P number of replayers may recover meta data MD based on allocated journal fragments. That is, in FIG. 18, the journal data replayer 212 includes a first replayer 241 and a second replayer 242, but it is not necessarily limited thereto, and the journal data replayer 212 may be implemented as including P number of replayers.

The first replayer 241 may perform replay based on journals of the first journal region. That is, the first replayer 241 may recover the meta data MD of the meta buffer 231 using the first journal, fourth journal, and fifth journal.

The second replayer 242 may perform replay based on journals of the second journal region. That is, the second replayer 242 may recover the meta data MD of the meta buffer 231 using the sixth journal, seventh journal, ninth journal, and tenth journal.

Since the first to tenth journal have no dependencies, the first replayer 241 and the second replayer 242 may perform replay simultaneously. In other words, since the first replayer 241 and the second replayer 242 simultaneously perform recovery of the meta data MD, the recovery time can be shortened.

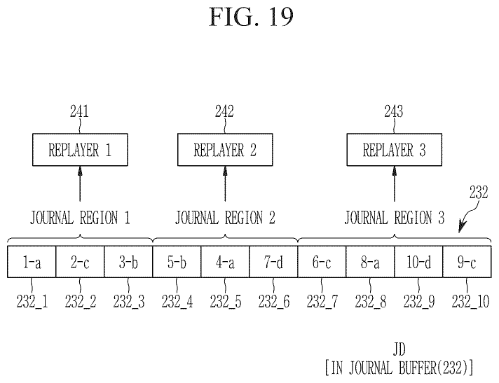

FIG. 19 is a diagram of an example of a configuration for a journal data replayer configured to perform journal replay according to some implementations. In FIGS. 17 to 19, the journal data replayer 212 may split the journal data JD of the journal buffer 232. The journal buffer 232 may include a plurality of memories 232_1 to 232_10. The journal data JD includes first to tenth journals and may be stored in the plurality of memories 232_1 to 232_10. The first journal to the ten journal may have no dependencies. The first journal may instruct to record data “a” in the meta data address “1”, the second journal may instruct to record data “c” in the meta data address “2”, the third journal may instruct to record the data “b” in the meta data address “3”, the fourth journal may instruct to record the data “a” in the meta data address “5”, the fifth journal may instruct to record data “c” in the meta data address “4”, the sixth journal may instruct to record data “d” in the meta data address “7”, the seventh journal may instruct to record the data “c” in the meta data address “6”, the eighth journal may instruct to record the data “a” in the meta data address “8”, ninth journal may instruct to record the data “d” in the meta data address “10”, and the tenth journal may instruct to record the data “c” in the meta data address “9”.

In the journal data JD of FIG. 19, journals with duplicate meta data addresses are invalidated. In other words, the existing journal may be deleted due to recording in a new journal. In some embodiments, the first to ten journal may not contain valid fields.

The journal data replayer 212 may split the journal data JD of the journal buffer 232 into a first journal region JOURNAL REGION 1, a second journal region JOURNAL REGION 2, and a third journal region JOURNAL REGION 3. The first journal region may include the first to third journals, the second journal region may include the fourth to sixth journals, and the third journal region may include the seventh to tenth journals.

The journal data replayer 212 may include a first replayer (REPLAYER1) 241, a second replayer (REPLAYER2) 242, and a third replayer (REPLAYER3) 243. In an embodiment, the first replayer 241, the second replayer 242, and the third replayer 243 may be implemented as individual logic circuits. In some implementations, the first replayer 241, the second replayer 242, and the third replayer 243 may also be implemented as being included in the storage controller 110 of FIG. 1.

The number of replayers included in the journal data replayer 212 may be determined according to the specifications of the manufacturer of the storage device 200. The description of FIG. 18 may be equally applied to the number of replayers included in the journal data replayer 212. That is, although FIG. 19 shows that journal data replayer 212 includes the first replayer 241, the second replayer 242, and the third replayer 243, the implementations are not necessarily limited thereto, and the journal data replayer 212 may be implemented as including various numbers of replayers.

The number of journals processed by each of the replayers 241, 242, and 243 may vary. In some implementations, the number (e.g., 10) of journals processed by each of the replayers 241, 242, and 243 may be determined based on a divided value (e.g., 10/3) obtained by dividing the number of journals included in the journal data JD by the number (e.g., 3) of replayers 241, 242, and 243. The divided value may be a decimal number.

In some implementations, when the divided value is a decimal number rather than an integer, the number of processing journals may be determined by rounding the divided value. For example, the first replayer 241 may process three journals. The second replayer 242 may also process three journals. The third repeater 243 may process the remaining four journals.

The first replayer 241 may perform replay based on journals of the first journal region. That is, the first replayer 241 may recover the meta data MD of the meta buffer 231 using the first to third journals.

The second replayer 242 may perform replay based on journals of the second journal region. That is, the second replayer 242 may recover the meta data MD of the meta buffer 231 using the fourth to sixth journals.

The third replayer 243 may perform replay based on journals of the third journal region. That is, the third replayer 243 may recover the meta data MD of the meta buffer 231 using the seventh to tenth journals.

Since the first to tenth journal have no dependencies, the first replayer 241, the second replayer 242, and the third replayer 243 may simultaneously perform replays. That is, since the first replayer 241, the second replayer 242, and the third replayer 243 simultaneously perform recovery of the meta data MD, recovery time can be shortened.

In some implementations, when the divided value is a decimal number rather than an integer, the number of processing journals may be determined by rounding up the divided value. For example, the first replayer 241 may process four journals. The second replayer 242 may also process four journals. The third replayer 243 may process the remaining two journals.

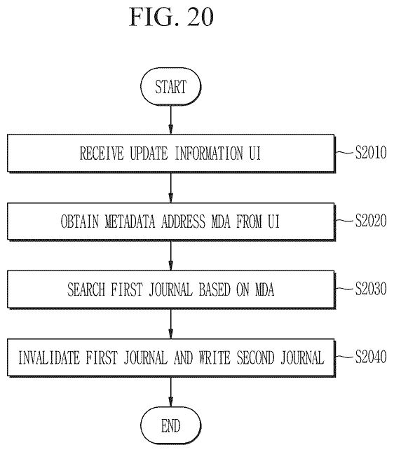

FIG. 20 is a flowchart of an example of a journal data generation method according to some implementations. In FIG. 20, a journal manager may generate journal data. Specifically, the journal manager may receive update information according to update of meta data (S2010). According to instructions of a host, a storage controller may write data to a non-volatile memory. When the data stored in the non-volatile memory changes, meta data can be updated.

The journal manager may obtain a first meta data address from the update information (S2020). Update information received according to the update of meta data may include a meta data address and update data.

The journal manager may search for a first journal based on the first meta data address (S2030). For example, the journal manager may use a journal search table to search for the first journal corresponding to the first meta data address. The journal search table may store at least one meta data address and at least one journal buffer identifier.

The journal manager may invalidate the first journal and record update information as a second journal (S2040).

In some implementations, the journal manager may invalidate the first journal by removing the journal information of the first journal from the journal search table. The journal manager may overwrite the journal information of the first journal with journal information of the second journal. In some implementations, the journal manager may invalidate the first journal by correcting a value of a valid field of the first journal. For example, a journal with a valid field value of “1” may be valid, and a journal with a valid field value of “0” may be invalid. When the journal manager generates a new journal, a value a valid field of the journal may be set to “1”. The journal manager may invalidate the journal by changing the value of the valid field from “1” to “0”.

In some implementations, the journal manager may record the second journal in the journal buffer following the most recently generated third journal. In some implementations, the journal manager may overwrite the second journal into the memory where the first journal is positioned in the journal buffer.

The journal manager may record the second journal in the journal buffer and record the journal information of the second journal in the journal search table.

The journal manager may obtain the journal buffer identifier of the memory where the second journal is positioned in the journal buffer. The journal manager may record the journal buffer identifier and first meta data address in the journal search table.

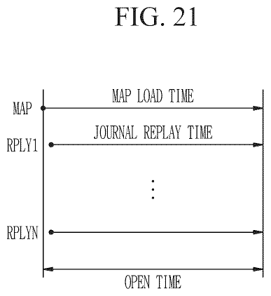

FIG. 21 is a diagram of an example of an open time of the storage device according to some implementations. In FIG. 21, in the storage device, a plurality of replayers REPLY1 to REPLYN may perform journal replay in parallel. For example, a first replayer REPLY1 may perform journal replay based on a first journal fragment of journal data. An N-th replayer REPLYN may perform journal replay based on an Nth journal fragment of the journal data.

Accordingly, the open time of the storage device may be shortened by plurality of replayers REPLY1 to REPLYN performing journal replay in parallel. N, which is the number of plurality of replayers REPLY1 to REPLYN, may be determined based on a map load time. The map load time may be understood as a time taken for meta data in the non-volatile memory to be loaded into the meta buffer. For example, N may be determined such that the time taken for one replayer to perform journal replay divided by N is less than or equal to the map load time. The journal data is divided into N journal fragments, and N replayers may perform journal replay in parallel.

In FIG. 21, the journal replay time is shorter than the map load time. However, it is not necessarily limited thereto, and the journal replay time may be implemented to be longer than the map load time. In this case, the open time may be relatively longer.

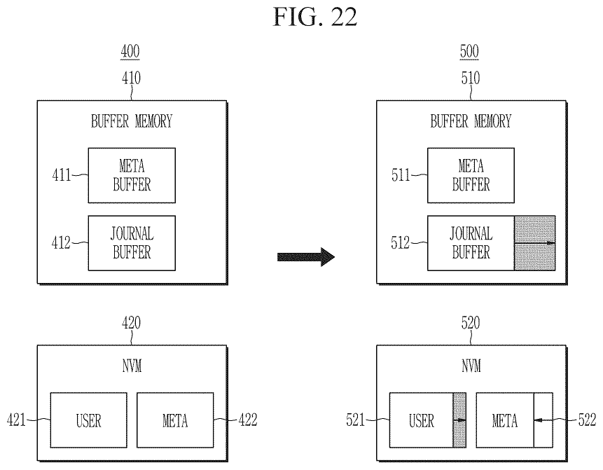

FIG. 22 is a diagram of an example of a capacity of a storage device according to some implementations. In FIG. 22, a storage device 500 may include a buffer memory 510 and a non-volatile memory 520. The buffer memory 510 may include a meta buffer 511 storing meta data and a journal buffer 512 storing journal data. The non-volatile memory 520 may include a user region 521 storing user data and a meta region 522 storing meta data and journal data. In some implementations, the meta region 522 may be an SLC region.

The storage device 500 may remove dependencies between journals when generating journal data. That is, the storage device 500 may generate journal data with no dependency. Since the journal data generated by storage device 500 has no dependency, replay can be performed in journal in parallel, and the open time of storage device 500 can be shortened. Accordingly, storage device 500 may have a larger capacity (size) of the journal buffer 512 than an existing storage device 400.

The existing storage device 400 may include a buffer memory 410 and a non-volatile memory 420. The buffer memory 410 may include a meta buffer 411 storing meta data and a journal buffer 412 storing journal data. The non-volatile memory 420 may include a user region 421 storing user data and a meta region 422 storing meta data and journal data. Journal data generated by the existing storage device 400 may include journals have dependencies.

The capacity of the journal buffer 512 may be determined in advance according to the specifications of the manufacturer of the storage device 500. The capacity of the meta region 522 in the non-volatile memory 520 may also be determined based on the capacity of the journal buffer 512. For example, as the journal replay time of storage device 500 is shortened, the capacity of the journal buffer 512 may increase.

As the capacity of the journal buffer 512 of the storage device 500 increases, the frequency with which journal data in the journal buffer 512 is moved to the non-volatile memory 520 may decrease. As the movement frequency of journal data decreases, the movement frequency of meta data in the meta buffer 511, which is moved along with the journal data, may also decrease. In some implementations, the capacity of the meta buffer 511 may also increase as the capacity of the journal buffer 512 increases.

As the movement frequency of the meta data decreases, the size of the meta region 522 of the non-volatile memory 520 may be smaller than that of the meta region 422 of the existing storage device 400. Accordingly, the user region 521 in the non-volatile memory 520 may have a larger capacity than the user region 421 of the existing storage device 400. In other words, the capacity allocated to the user of storage device 500 may increase.

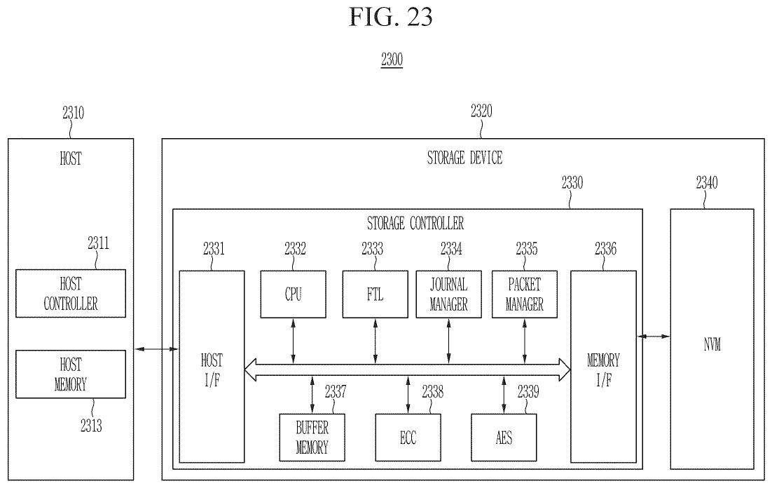

FIG. 23 is a block diagram of an example of a computing system according to some implementations. In FIG. 23, a computing system 2300 may be a personal computer (PC), a laptop computer, a server, a media player, a digital camera, a navigation, a black box, vehicle electrical equipment, and the like. Alternatively, the computing system 2300 may be a mobile system such as a portable communication terminal, a smartphone, a tablet PC, wearable device, a healthcare device, or an Internet of Things (IOT) device. In addition, the computing system 2300 may be implemented as a system-on-a-chip (SoC).

The computing system 2300 may include a host 2310 and a storage device 2320. The host 2310 may communicate with the storage device 2320 through various interfaces. The host 2310 may request a data processing operation, for example, a data read operation, a data program operation, and a data erase operation, to the storage device 2320. For example, the host 2310 may be a central processing unit (CPU), a graphics processing unit (GPU), a neural processing unit (NPU), a data processing unit (DPU), an application processor (AP), a microprocessor, and the like.

The host 2310 may include a host controller 2311 and a host memory 2313. The host memory 2313 may function as a buffer memory to temporarily store data to be transmitted to the storage device 2320 or data transmitted from the storage device 2320.

The storage device 2320 may include a storage controller 2330 and a non-volatile memory (NVM) 2340. The storage device 2320 may include storage media for storing data according to a request from the host 2310. For example, the storage device 2320 may be implemented in various types such as SSD, eMMC, UFS, CF, SD, Micro-SD, Mini-SD, xD, or memory stick.

When the storage device 2320 is an SSD, the storage device 2320 may be a device that follows the NVMe standard. When the storage device 2320 is an embedded memory or external memory, the storage device 2320 may be a device that complies with the UFS standard or eMMC standard. The host 2310 and the storage device 2320 each may generate and transmit packets according to the adopted standard protocol.

When the non-volatile memory 2340 of the storage device 2320 includes a flash memory, the flash memory may include a 2D NAND memory array or a 3D NAND memory array. As another example, the storage device 2320 may include various other types of non-volatile memories. For example, the storage device 2320 may be equipped with various other types of memory such as MRAM, STT-RAM, CBRAM, FRAM, PRAM, and RRAM.

In some implementations, the host controller 2311 and the host memory 2313 may be implemented as separate semiconductor chips. Alternatively, in some implementations, the host controller 2311 and the host memory 2313 may be integrated on the same semiconductor chip. As an example, the host controller 2311 may be one of a plurality of modules provided in an AP, and the AP may be implemented as an SoC. In addition, the host memory 2313 may be an embedded memory provided within the AP, or a non-volatile memory or memory module placed outside the AP.

The host controller 2311 may manage operations of storing data (e.g., write data) of the buffer region in the non-volatile memory 2340 or storing data (e.g., read data) of the non-volatile memory 2340 in the buffer region.

The storage controller 2330 may include a host interface 2331, a CPU 2332, and a memory interface 2336. In addition, the storage controller 2330 may further include a flash conversion layer (FTL) 2333), a journal manager 2334, a packet manager 2335, a buffer memory 2337, and an error correction code (ECC) engine 2338, and an advanced encryption standard (AES) engine 2339.

The storage controller 2330 may further include a working memory into which the FTL 2333 is loaded, and the data write operation and read operation for non-volatile memory may be controlled by the CPU 2332 executing the flash conversion layer 2333.

The host interface 2331 may transmit and receive packets with the host 2310. The packet transmitted from the host 2310 to the host interface 2331 may include a command or data to be written to the non-volatile memory 2340, and the packet transmitted from the host interface 2331 to the host 2310 may include a response to the command or data read from the non-volatile memory 2340.

The memory interface 2336 may transmit data to be written to the non-volatile memory 2340 to the non-volatile memory 2340, or receive data read from the non-volatile memory 2340. The memory interface 2336 may be implemented to comply with standard conventions such as Toggle or open NAND flash interface (ONFI or ONFI).

The flash conversion layer 2333 may perform several functions such as address mapping, wear-leveling, and garbage collection. The address mapping operation is an operation that changes a logical address received from the host into a physical address used to actually store data in the non-volatile memory 2340. The wear-leveling is a technology to prevent excessive degradation of specific blocks by ensuring that blocks in the non-volatile memory 2340 are used uniformly. For example, it may be implemented through a firmware technology that balances erase counts of physical blocks. The garbage collection is a technology to secure usable capacity within the non-volatile memory 2340 by copying valid data of a block to a new block and then erasing the existing block.

The journal manager 2334 may generate and manage journal data. The journal manager 2334 may remove dependency between journals when generating journal data. The journal manager 2334 may recover meta data by performing journal replay in parallel when the storage device 2320 is turned on. In some implementations, the journal manager 2334 may be provided within the CPU 2332. The contents described with reference to FIG. 1 to FIG. 22 may be equally applied to the journal manager 2334, the buffer memory 2337, and the non-volatile memory 2340.

The packet manager 2335 may generate a packet according to a protocol of an interface negotiated with the host 2310, or may parse various information from the packet received from the host 2310.

The buffer memory 2337 may store at least one of the meta data and the journal data. In addition, the buffer memory 2337 may temporarily store data to be programmed to the non-volatile memory 2340 or data to be read from the non-volatile memory 2340. The buffer memory 2337 may be provided within the storage controller 2330, but may also be placed outside the storage controller 2330.

The ECC engine 2338 may perform error detection and correction functions on read data read from the non-volatile memory 2340. More specifically, the ECC engine 2338 may generate parity bits with respect to data to be programmed to the non-volatile memory 2340, and the generated parity bits may be stored in the non-volatile memory 2340 together with the write data. When reading data from the non-volatile memory 2340, the ECC engine 2338 may correct errors in the read data using parity bits read from the non-volatile memory 2340 along with the read data and output read data with the errors corrected.

The AES engine 2339 may perform at least one of encryption and decryption operations on data input to the storage controller 2330 using a symmetric-key algorithm.

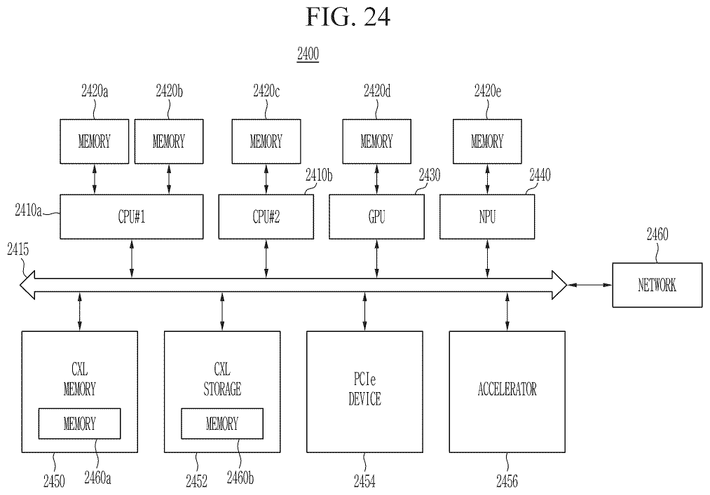

FIG. 24 is a block diagram of an example of a computing system according to some implementations. In FIG. 24, a computing system 2400 may include a first CPU 2410a, a second CPU 2410b, a GPU 2430, an NPU 2440, a CXL switch 2415, a CXL memory 2450, a CXL storage 2452, a PCle device 2454, and an accelerator (CXL device) 2456.

The first CPU 2410a, the second CPU 2410b, the GPU 2430, the NPU 2440, the CXL memory 2450, the CXL storage 2452, the PCIe device 2454, and the accelerator 2456 may be connected in common to the CXL switch 2415 and each may communicate with each other through the CXL switch 2415.

In some implementations, the first CPU 2410a, the second CPU 2410b, the GPU 2430, and the NPU 2440 each may be the host 11 described with reference to FIG. 1, and each may be directly connected with individual memories 2420a, 2420b, 2420c, 2420d, and 2420e.

The CXL storage 2452 may record, read, or erase data according to instructions of the first CPU 2410a, the second CPU 2410b, the GPU 2430, and the NPU 2440. The CXL storage 2452 may be the storage device described with reference to FIG. 1 to FIG. 23. That is, the CXL storage 2452 may generate journal data having no dependency between journals. When the CXL storage 2452 is turned on, the CXL storage 2452 may replay the journal data in parallel.

In some implementations, at least some regions of the memories 2460a and 2460b of the CXL memory 2450 and the CXL storage 2452 may be allocated a cache buffer of at least one of the first CPU 2410a, the second CPU 2410b, the GPU 2430, the NPU 2440, the CXL memory 2450, the CXL storage 2452, the PCIe device 2454, and the accelerator 2456 by one of or one or more of the first CPU 2410a, the second CPU 2410b, the GPU 2430, and NPU 2440.

In some implementations, the CXL switch 2415 may be connected with the PCIe device 2454 or the accelerator 2456 that are formed to support various functions, and the PCIe device 2454 or the accelerator 2456 may communicate with each of the first CPU 2410a, the second CPU 2410b, the GPU 2430, and the NPU 2440 through the CXL switch 2415 or may access the CXL memory 2450 and the CXL storage 2452.

In some implementations, the CXL switch 2415 may be connected to an external network 2460 or fabric and may be configured to communicate with an external server through the external network 2460 or fabric.

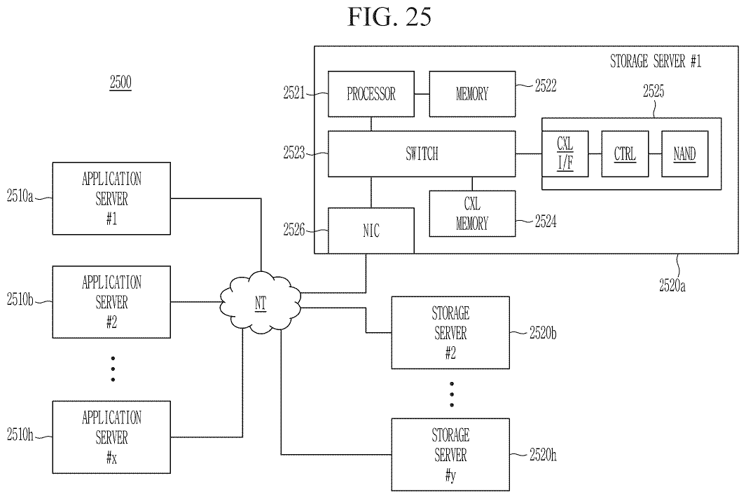

FIG. 25 is a block diagram of an example of a data center to which a computing system is applied according to some implementations. In FIG. 25, a data center 2500 is a facility that collects various data and provides services, and may be referred to as a data storage center. The data center 2500 may be a system for operating a search engine and database, and may be a computing system used in companies such as banks or government agencies. The data center 2500 may include application servers 2510a to 2510h and storage servers 2520a to 2520h. The number of application servers and the number of storage servers may be selected in various ways depending on implementations, and the number of application servers and the number of storage servers may be different.

Hereinafter, the configuration of the first storage server 2520a will be described in detail. The application servers 2510a to 2510h and the storage servers 2520a to 2520h may respectively have similar structures, and the application servers 2510a to 2510h and the storage servers 2520a to 2520h may communicate with each other through a network NT.

A first storage server 2520a may include a processor 2521, a memory 2522, a switch 2523, a CXL memory 2524, a storage device 2525, and a network interface card (NIC) 2526. The processor 2521 may control the overall operation of the first storage server 2520a and may access the memory 2522 to execute instructions loaded in a memory 2522 or process data. The memory 2522 may be a double data rate synchronous DRAM (DDR SDRAM), a high bandwidth memory (HBM), a hybrid memory cube (HMC), a dual in-line memory module (DIMM), Optane DIMM and/or non-volatile DIMM (NVDIMM). The processor 2521 and the memory 2522 may be directly connected, and the number of processors 2521 and the number of memories 2522 included in the storage server 2520a may be variously selected.

In some implementations, the processor 2521 and the memory 2522 may provide a processor-memory pair. In some implementations, the number of processors 2521 and the number of memories 2522 may be different. The processor 2521 may include a single core processor or a multi-core processor. The above description of the storage server 2520a may be similarly applied to each of application servers 2510a to 2510h.

The switch 2523 may be configured to mediate or route communication between various configuration elements included in the first storage server 2520a. In some implementations, the switch 2523 may be an interface or a CXL switch. The switch 2523 may be a switch implemented based on the CXL protocol.

The CXL memory 2524 may be connected with the switch 2523. In some implementations, the CXL memory 2524 may be used as a memory expander for the processor 2521. Alternatively, the CXL memory 2524 may be allocated as a dedicated memory or buffer memory for the storage device 2525.

The storage device 2525 may include a CXL interface circuit CXL_IF, a controller CTRL, and a NAND flash. The storage device 2525 may store data, output or erase the stored data at a request of the processor 2521.

In some implementations, the storage device 2525 may be the storage device described with reference to FIGS. 1 to 24. That is, the storage device 2525 may generate journal data without dependencies between journals. When the storage device 2525 is turned on, the storage device 2525 may replay journal data in parallel.

The NIC 2526 may be connected with the switch 2523. The NIC 2526 may communicate with other storage servers 2520b to 2520h or other application severs 2510a to 2510h through the network NT.

In some implementations, the NIC 2526 may include a network interface card, a network adaptor, and the like. The NIC 2526 may be connected to the network NT by a wired interface, a wireless interface, a Bluetooth interface, an optical interface, and the like. The NIC 2526 may include an internal memory, a digital signal processor (DSP), a host bus interface, and the like, and may be connected with the processor 2521 and/or switch 2523 through the host bus interface. In some implementations, the NIC 2526 may be integrated with at least one of the processor 2521, the switch 2523, and the storage device 2525.

In some implementations, the network NT may be implemented using a fibre channel (FC) or an ethernet. In this case, the FC is a medium used for relatively high-speed data transmission, and an optical switch that provides high performance/high availability may be used. Depending on an access method of the network NT, the storage servers may be provided as a file storage, a block storage, or an object storage.

In some implementations, the network NT may be a dedicated storage network, such as a storage area network (SAN). For example, the SAN may be an FC-SAN that uses an FC network and is implemented according to the FC Protocol (FCP). As another example, the SAN may be an IP-SAN that uses a TCP/IP network and is implemented according to the iSCSI (SCSI over TCP/IP or Internet SCSI) protocol. In some implementations, the network NT may be a general network such as a TCP/IP network. For example, the network NT may be implemented according to protocols such as a FC over Ethernet (FCOE), a network attached storage (NAS), and NVMe over fabrics (NVMe-oF).

In some implementations, at least one of the application servers 2510a to 2510h may store data requested by a user or client to one of the storage servers 2520a to 2520h through the network NT. At least one of the application servers 2510a to 2510h may obtain data requested by a user or client to be read from one of the storage servers 2520a to 2520h through the network NT. For example, at least one of the application servers 2510a to 2510h may be implemented as a web server or a database management system (DBMS).

In some implementations, at least one of the application servers 2510a to 2510h may access a memory, a CXL memory, or a storage device included in another application server through the network NT, or may access memories, CXL memories, or storage devices included in the storage servers 2520a through the network NT. Accordingly, at least one of the application servers 2510a to 2510h may perform various operations on data stored in other application servers and/or storage servers. For example, at least one of the application servers 2510a to 2510h may execute instructions to move or copy data between other application servers and/or storage servers. In this case, data may be moved from the storage devices of the storage servers through the memories or CXL memories of the storage servers, or directly to the memory or CXL memory of the application servers. Data moving through the network may be encrypted for security or privacy.

In some implementations, the storage device included in at least one of application servers 2510a to 2510h and the storage servers 2520a to 2520h may be allocated with the CXL memory included in at least one of application servers 2510a to 2510h and the storage servers 2520a to 2520h as a dedicated region, and the storage device may use the allocated dedicated region as a buffer memory (e.g., to store meta data). For example, the storage device 2525 included in the storage server 2520a may be allocated with a CXL memory included in another storage server (e.g., 2520h), and may access a CXL memory included in another storage server (e.g., 2520h) through the switch 2523 and the NIC 2526. In this case, meta data for the storage device 2525 of the first storage server 2520a may be stored in the CXL memory of the other storage server 2520h. In other words, the storage devices and the CXL memories of the data center 2500 according to the present disclosure may be connected and implemented in various ways.

In some implementations, each component or combination of two or more components described with reference to FIGS. 1 to 25 may be implemented as a digital circuit, programmable or non-programmable logic device or array, application specific integrated circuit (ASIC), and the like.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A journal data generation method of a storage device, comprising:
receiving update information of meta data;
obtaining a first meta data address from the update information;
searching for a first journal having a second meta data address that matches the first meta data address;
invalidating the first journal; and
recording the update information as a second journal in a journal buffer where the first journal is recorded.

2. The journal data generation method of claim 1, wherein searching for the first journal comprises:
searching for the first journal having the second meta data address using a journal search table that stores at least one meta data address and at least one journal buffer identifier.

3. The journal data generation method of claim 2, further comprising recording journal information of the second journal in the journal search table.

4. The journal data generation method of claim 3, wherein:
recording the journal information of the second journal in the journal search table comprises:
obtaining a journal buffer identifier of a memory where the second journal is located in the journal buffer; and
recording the journal buffer identifier and the first meta data address in the journal search table.

5. The journal data generation method of claim 4, wherein recording the update information as the second journal comprises:
recording the second journal following a most recently generated third journal in the journal buffer, and wherein the journal data generation method further comprises:
removing journal information of the first journal from the journal search table.

6. The journal data generation method of claim 1, wherein recording the update information as the second journal comprises:
correcting a value of a valid field of the first journal.

7. The journal data generation method of claim 6, wherein recording the update information as the second journal further comprises:
recording the second journal following the most recently generated third journal in the journal buffer.

8. The journal data generation method of claim 1, wherein recording the update information as the second journal comprises:
overwriting the second journal to a memory where the first journal is located in the journal buffer.

9. A method comprising:
obtaining meta data;
obtaining journal data that corresponds to the meta data, and includes journals of which meta data addresses are different from each other;
dividing the journal data into at least two journal fragments; and
recovering the meta data in parallel based on the at least two journal fragments by a plurality of replayers.

10. The method of claim 9, wherein dividing the journal data into at least two journal fragments comprises:
dividing the journal data based on a number of the plurality of replayers.

11. A storage device comprising:
a journal manager configured to determine a first journal corresponding to update information of metal data from among journal data when receiving the update information, and to invalidate the first journal and generates a second journal; and
a buffer memory configured to store the meta data and the journal data.

12. The storage device of claim 11, wherein the journal manager is configured to determine whether the first journal matches a meta data address of the update information.

13. The storage device of claim 12, wherein the journal manager is configured to determine that the first journal matches the meta data address of the update information using a journal search table that stores journal information of the journal data.

14. The storage device of claim 13, wherein the journal manager is configured to generate the second journal and update the journal search table.

15. The storage device of claim 11, wherein the journal manager is configured to invalidate the first journal by changing a value of a valid field of the first journal.

16. The storage device of claim 11, wherein the journal manager is configured to invalidate the first journal by overwriting the second journal in the buffer memory at a position where the first journal is recorded.

17. The storage device of claim 11, further comprising a non-volatile memory configured to store data,
wherein the buffer memory is configured to record the meta data and the journal data in the non-volatile memory.

18. The storage device of claim 17,
wherein the buffer memory comprises:
a meta buffer configured to store the meta data; and
a journal buffer configured to store the journal data, and
wherein when the journal buffer is full, the buffer memory is configured to record the meta data and the journal data in the non-volatile memory.

19. The storage device of claim 17, wherein:
the non-volatile memory is configured to transmit the journal data and the meta data to the buffer memory when the storage device is turned on, and
the journal manager is configured to divide the journal data into plurality of journal fragments and perform replay in parallel based on the plurality of journal fragments.

20. The storage device of claim 19, wherein the journal manager comprises:
a first replayer configured to recover the meta data based on a first journal fragment among the plurality of journal fragments; and
a second replayer configured to recover the meta data based on a second journal fragment among the plurality of journal fragments.
